(19) United States
(12) Patent Application Publication
(10) Pub. No.: US 2026/0026651 A1
(43) Pub. Date: Jan. 29, 2026

(54) Combination Grill and Griddle Device

(71) Applicant: Roger Fordyce, Roseville, CA (US)

(72) Inventor: Roger Fordyce, Roseville, CA (US)

(21) Appl. No.: 19/064,878

(22) Filed: Feb. 27, 2025

Related U.S. Application Data
(60) Provisional application No. 63/674,310, filed on Jul. 23, 2024.

(51) Int. Cl. A47J 37/06; A47J 37/07

(52) U.S. Cl. CPC A47J 37/0676; A47J 37/0709; A47J 37/0786

(57) ABSTRACT

A combination grill and griddle device is provided. The device integrates both a traditional grill and a flat-top griddle into a single unit, providing a versatile cooking solution for various outdoor settings. The device comprises a griddle surface and a slotted grate surface. A grease management system with a channel and removable collection member integrated not the griddle surface ensures the disposal of cooking residue. The device may use various fuel sources, including propane, natural gas, or electricity, and features multiple heating elements with independent heat controls for uniform cooking performance. A built-in lid with venting and an integrated thermometer enables temperature regulation for additional cooking functions such as smoking and roasting.

### CROSS-REFERENCE TO RELATED APPLICATION

The present application claims priority to, and the benefit of, U.S. Provisional Application No. 63/674,310, which was filed on Jul. 23, 2024, and is incorporated herein by reference in its entirety.

### FIELD OF THE INVENTION

The present invention relates generally to the field of grilling and cooking devices. More specifically, the present invention relates to a device that integrates both a traditional grill and a flat-top griddle into a single unit, providing a versatile cooking solution for various outdoor settings. Accordingly, the present disclosure makes specific reference thereto. Nonetheless, it is to be appreciated that aspects of the present invention are also equally applicable to other like applications, devices, and methods of manufacture.

### BACKGROUND

Traditional grill grates are not suitable for preparing all components of a meal, such as pancakes, eggs, or delicate seafood, which require a flat cooking surface. While some users may utilize separate griddles alongside their grills, this requires additional equipment and space, leading to inconvenience. Furthermore, maintaining multiple cooking appliances increases complexity in terms of fuel management, cleaning, and overall setup. Users may also struggle with heat distribution and grease management when attempting to cook different foods simultaneously on a grill. As such, a need exists for an integrated cooking solution that allows users to grill and use a griddle at the same time without requiring separate appliances.

Therefore, there exists a long-felt need in the art for a combination grill and griddle device that enables users to cook a variety of foods on a single appliance without requiring additional cooking equipment. There also exists a long-felt need in the art for a combination grill and griddle device that provides independent temperature control for the grill and griddle surfaces, allowing for precise cooking adjustments. Moreover, there exists a long-felt need in the art for a combination grill and griddle device that incorporates effective grease management and heat distribution features to enhance cooking performance and case of maintenance.

The subject matter disclosed and claimed herein, in one embodiment thereof, comprises a combination grill and griddle device. The device integrates both a traditional grill and a flat-top griddle into a single unit, providing a versatile cooking solution for various outdoor settings. The device comprises a griddle surface and a slotted grate surface. A grease management system with a channel and removable collection member integrated not the griddle surface ensures the disposal of cooking residue. The device may use various fuel sources, including propane, natural gas, or electricity, and features multiple heating elements with independent heat controls for uniform cooking performance. A built-in lid with venting and an integrated thermometer enables temperature regulation for additional cooking functions such as smoking and roasting.

In this manner, the combination grill and griddle device of the present invention accomplishes all the forgoing objectives and provides a cooking device that integrates a slotted grill grate with a flat-top griddle into a single unit, allowing users to prepare a variety of foods simultaneously. The separate heating elements for the grill and griddle surfaces further enable independent temperature adjustments for optimal cooking control. Further, the grease channel and collection system of the griddle ensures easy disposal of excess oil and reduces cleanup time. The device may be powered by propane, gas, or electricity, offering flexibility in fuel options to accommodate different user preferences. By providing a versatile, efficient, and user-friendly cooking solution, the combination grill and griddle device improves the outdoor grilling experience while eliminating the need for multiple appliances.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a combination grill and griddle device. The combination grill and griddle device integrates a traditional grill with a flat-top griddle, providing a versatile cooking solution for various outdoor activities. By allowing simultaneous use of both cooking surfaces, the device enhances efficiency and expands cooking possibilities. More specifically, the device comprises a griddle surface and a slotted grate surface, which can be configured in different sizes and shapes. A grease channel is integrated along at least one perimeter edge of the griddle surface to direct excess grease into a removable grease collection member. The griddle surface may have a slight downward slope toward the grease collection member to facilitate drainage. A secondary warming rack may be positioned above the grate surface.

The device operates using a fuel source, which may include electric power, propane, or natural gas. It incorporates at least one heating element, such as gas burners, electric coils, or infrared heaters, positioned beneath the cooking surfaces. A heat control knob allows independent temperature adjustments, while multiple heating elements ensure uniform heat distribution. An ignition system provides a spark for immediate activation, and propane-powered models include a built-in fuel gauge for real-time monitoring. A built-in lid or hood retains heat for smoking, roasting, and slow cooking. The hood includes at least one vent to regulate airflow and temperature. An integrated thermometer, either analog or digital, allows users to monitor internal temperatures with high visibility.

Accordingly, the combination grill and griddle device of the present invention is particularly advantageous as it provides a cooking device that integrates a slotted grill grate with a flat-top griddle into a single unit, allowing users to prepare a variety of foods simultaneously. The separate heating elements for the grill and griddle surfaces further enable independent temperature adjustments for optimal cooking control. Further, the grease channel and collection system of the griddle ensures easy disposal of excess oil and reduces cleanup time. The device may be powered by propane, gas, or electricity, offering flexibility in fuel options to accommodate different user preferences. By providing a versatile, efficient, and user-friendly cooking solution, the combination grill and griddle device improves the outdoor grilling experience while eliminating the need for multiple appliances. In this manner, the combination grill and griddle device overcomes the limitations of existing grills and griddles known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a top perspective view of one potential embodiment of a combination grill and griddle device of the present invention while open in accordance with the disclosed architecture; and

FIG. 2 illustrates a front view of one potential embodiment of a combination grill and griddle device of the present invention while closed in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a combination grill and griddle device that enables users to cook a variety of foods on a single appliance without requiring additional cooking equipment. There also exists a long-felt need in the art for a combination grill and griddle device that provides independent temperature control for the grill and griddle surfaces, allowing for precise cooking adjustments. Moreover, there exists a long-felt need in the art for a combination grill and griddle device that incorporates effective grease management and heat distribution features to enhance cooking performance and ease of maintenance.

The present invention, in one exemplary embodiment, is comprised of a combination grill and griddle device. The combination grill and griddle device integrates a traditional grill with a flat-top griddle, offering a versatile cooking solution for outdoor activities. By enabling simultaneous use of both cooking surfaces, the device increases efficiency and expands cooking options. Specifically, the device includes a griddle surface and a slotted grate surface, which can be configured in various sizes and shapes. A grease channel is positioned along at least one perimeter edge of the griddle surface to direct excess grease into a removable grease collection member. To facilitate drainage, the griddle surface may have a slight downward slope toward the grease collection member. A secondary warming rack may be located above the grate surface.

The device operates using a fuel source, which may include electric power, propane, or natural gas. It incorporates at least one heating element, such as gas burners, electric coils, or infrared heaters, positioned beneath the cooking surfaces. A heat control knob allows for independent temperature adjustments, while multiple heating elements ensure even heat distribution. An ignition system provides a spark for immediate activation, and propane-powered models feature a built-in fuel gauge for real-time monitoring. A built-in lid or hood retains heat for smoking, roasting, and slow cooking. The hood is designed with at least one vent to regulate air flow and temperature. An integrated thermometer, available in analog or digital form, enables users to monitor internal temperatures with high visibility.

As a result, the combination grill and griddle device provides a cooking solution that integrates a slotted grill grate with a flat-top griddle in a single unit, allowing users to prepare multiple foods at once. Independent heating elements for the grill and griddle surfaces enable precise temperature control for optimal cooking performance. Additionally, the grease channel and collection system facilitate the easy disposal of excess oil, reducing cleanup time. The device may be powered by propane, gas, or electricity, offering flexibility in fuel options to suit different user preferences. By delivering a versatile, efficient, and user-friendly cooking experience, the combination grill and griddle device enhances outdoor grilling while eliminating the need for multiple appliances. In this way, the device overcomes the limitations of conventional grills and griddles.

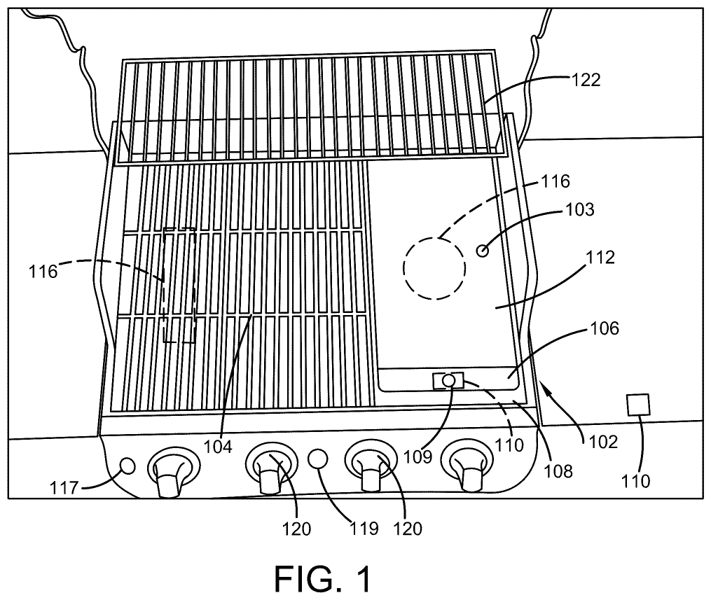

Referring initially to the drawings, FIG. 1 illustrates a top perspective view of one potential embodiment of a combination grill and griddle device 100 of the present invention while open in accordance with the disclosed architecture. The combination grill and griddle device 100 is designed to integrate the functionalities of a traditional grill with a flat-top griddle, offering a versatile cooking solution suitable for backyard grilling, camping, and tailgating. By allowing simultaneous use of both cooking surfaces, the device 100 enhances efficiency and expands cooking possibilities.

More specifically, the device 100 is comprised of a griddle surface 102 and a slotted grate surface 104 as seen in FIG. 1, which may be configured in various combinations of size and shape to accommodate different cooking needs. The griddle surface 102 may be made from cast iron or cold-rolled steel. Cast iron offers superior durability and heat distribution, while cold-rolled steel heats quickly and provides a smooth, easy-to-maintain surface. The griddle surface 102 may have a pre-seasoned or coated finish 103 to prevent food from sticking and to enhance its longevity. The device may also be made from cast aluminum, Seasoned and Teflon coated nonstick.

To facilitate grease management, the griddle surface 102 is further comprised of at least one grease channel 106 that is integrated along at least one perimeter edge 108, as seen in FIG. 1. The grease channel 106 is designed with a slightly recessed profile, ensuring that excess oil and cooking residue naturally flow toward at least one opening 109, which leads directly into a removable grease collection member 110. The grease collection member 110 may be a removable cup, tray, container, etc. allowing for easy disposal of grease and residue. In one embodiment, the top surface 112 of the griddle surface 102 is engineered with a slight downward slope of at least 1 degree toward the grease collection member 110, promoting drainage and preventing grease from pooling on the cooking surface. The degree of slope may vary depending on the specific embodiment, ensuring that the flow of grease is controlled without interfering with food placement or cooking performance.

The remaining portion of the cooking area is occupied by the slotted grate surface 104, which may be made from materials such as porcelain-coated cast iron, stainless steel, or other high-temperature-resistant alloys. The spacing and width of the slots in the grate surface 104 may vary and may be optimized to balance heat exposure and airflow while preventing smaller food items from falling through. The device 100 may also have a secondary warming rack 122 positioned above and made from the same material as the slotted grate surface 104.

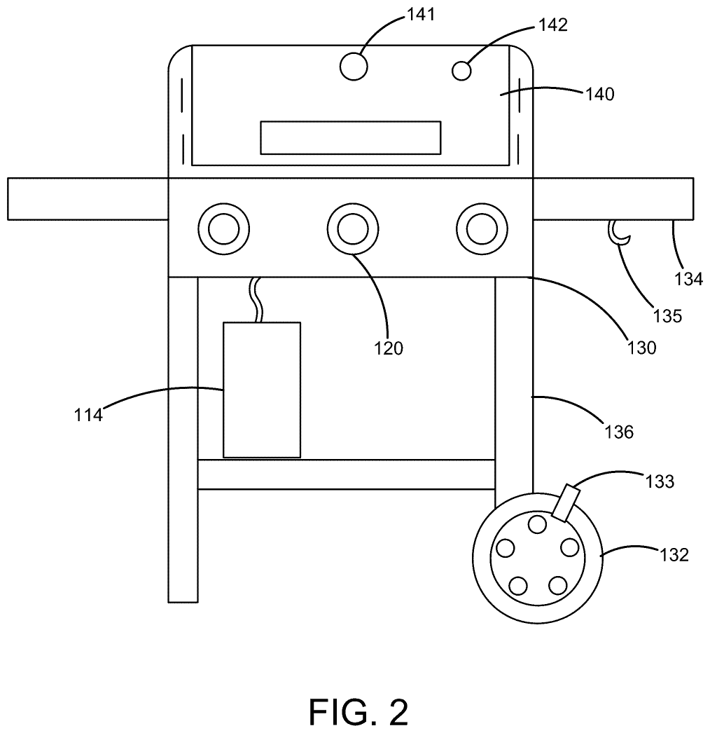

In different embodiments, the device 100 operates using a fuel source 114 that may include but is not limited to an electric battery, propane, or natural gas, as seen in FIG. 2. In electric embodiments, the fuel source 114 may include a rechargeable lithium-ion batteries or a standard AC power connection. The device 100 is also comprised of at least one heating element 116, positioned beneath the griddle surface 102 and the slotted grate surface 104. The heating element 116 may include but is not limited to, gas burners, electric coils, or infrared heating elements. The device 100 is also comprised of at least one heat control knob 120, which allows for independent temperature adjustments of each heating element 116. Multiple heating elements 116 may be distributed strategically across the cooking surfaces to provide uniform heat dispersion, eliminate hot spots, and ensure consistent cooking performance. The device 100 further includes an ignition system 117, which may be in the form of a push-button or electronic ignition mechanism. The ignition system 117 is designed to deliver a reliable spark for immediate heating element 116 activation. For propane-powered models, a built-in fuel gauge 119 is integrated to monitor fuel levels, preventing unexpected shutdowns. The fuel gauge 119 may be analog or digital, displaying real-time fuel capacity for accurate monitoring.

The device 100 is also comprised of a frame 130 that provides structural support and stability, as seen in FIG. 2. In one embodiment, the frame 130 is configured as a holding frame for transportability, ensuring that the device 100 can be easily relocated. To enhance mobility, the frame 130 may be equipped with wheels 132, which allow for easy movement across various terrains. The wheels 132 may be constructed from rubber, polyurethane, or another heat-resistant material to withstand prolonged exposure to high temperatures and outdoor elements. The wheels 132 may be comprised of a locking mechanism 133 to prevent unwanted movement during use.

Foldable or detachable side tables 134 are further integrated into the frame 130 to provide additional workspace for food preparation, utensils, and condiments, as seen in FIG. 2. The side tables 134 may feature built-in attachment points 135 such as but not limited to hooks or tool holders, allowing users to store grilling accessories within reach. The device 100 is further supported by legs 136 that enhance stability during use. In one embodiment, the legs 136 are telescopic and adjustable in height to accommodate uneven surfaces, ensuring a level cooking experience.

A built-in lid or hood 140 is integrated into the device 100 to retain heat and enable additional cooking functions such as smoking, roasting, and slow cooking. The hood 140 may also feature at least one venting 141 to regulate airflow, allowing users to control temperature and smoke levels as needed. An integrated thermometer 142 is positioned within the lid or hood 140, enabling users to monitor internal temperatures. The thermometer 142 may be analog or digital, with a high-visibility display to ensure easy readability during cooking.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “combination grill and griddle device” and “device” are interchangeable and refer to the combination grill and griddle device 100 of the present invention.

Notwithstanding the forgoing, the combination grill and griddle device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the combination grill and griddle device 100 as shown in the FIGS. are for illustrative purposes only, and that many other sizes and shapes of the combination grill and griddle device 100 are well within the scope of the present disclosure. Although the dimensions of the combination grill and griddle device 100 are important design parameters for user convenience, the combination grill and griddle device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A combination grill and griddle device comprising:
a body comprising a griddle surface and a slotted grate surface positioned adjacent to each other;
a grease channel integrated along a perimeter edge of the griddle surface;
a grease collection member configured to receive grease from the grease channel;
a fuel source;
a heating element;
a heat control knob configured to adjust the temperature of the heating element;
a frame; and
a wheel attached to the frame.

2. The combination grill and griddle device of claim 1, wherein the griddle surface is comprised of a pre-seasoned or a coated finish.

3. The combination grill and griddle device of claim 1, wherein the fuel source is comprised of an electric battery.

4. The combination grill and griddle device of claim 1, wherein the heating element is comprised of an electric coil.

5. The combination grill and griddle device of claim 1, wherein the heating element is comprised of an infrared heating element.

6. The combination grill and griddle device of claim 1, wherein the grease channel is comprised of a recessed channel.

7. A combination grill and griddle device comprising:
a body comprising a griddle surface and a slotted grate surface positioned adjacent to each other;
a grease channel integrated along a perimeter edge of the griddle surface;
a grease collection member configured to receive grease from the grease channel;
a fuel source;
a lid;
a warming rack positioned above the griddle surface and the slotted grate surface;
a heating element;
a heat control knob configured to adjust the temperature of the heating element;
a frame; and
a wheel attached to the frame.

8. The combination grill and griddle device of claim 7, wherein the fuel source is comprised of a propane.

9. The combination grill and griddle device of claim 7, wherein the heating element is comprised of a gas burner.

10. The combination grill and griddle device of claim 7, wherein the frame is comprised of a foldable side table.

11. The combination grill and griddle device of claim 10, wherein the side table is comprised of an attachment point.

12. The combination grill and griddle device of claim 7 further comprised of an ignition system.

13. The combination grill and griddle device of claim 7 further comprised of a fuel gauge.

14. A combination grill and griddle device comprising:
a body comprising a griddle surface and a slotted grate surface positioned adjacent to each other;
a grease channel integrated along a perimeter edge of the griddle surface;
a grease collection member configured to receive grease from the grease channel;
a fuel source;
a lid comprised of a vent;
a warming rack positioned above the griddle surface and the slotted grate surface;
a heating element;
a heat control knob configured to adjust the temperature of the heating element;
a frame; and
a wheel attached to the frame.

15. The combination grill and griddle device of claim 14, wherein the fuel source is comprised of a natural gas.

16. The combination grill and griddle device of claim 14, wherein the vent is adjustable to regulate airflow.

17. The combination grill and griddle device of claim 14 further comprised of an ignition system.

18. The combination grill and griddle device of claim 14 further comprised of a fuel gauge.

19. The combination grill and griddle device of claim 14 further comprised of a leg.

20. The combination grill and griddle device of claim 19, wherein the leg is comprised of a telescopic leg.
